(19) United States
(12) Patent Application Publication
(10) Pub. No.: US 2026/0133059 A1
(43) Pub. Date: May 14, 2026

(54) ULTRASOUND SENSOR ARRANGEMENT, APPARATUS AND METHOD OF TRANSMITTING OF ULTRASOUND

(71) Applicant: TEKNOLOGIAN TUTKIMUSKESKUS VTT OY, Espoo (FI)

(72) Inventors: Teuvo SILLANPÄÄ, Espoo (FI); Cyril KARUTHEDATH, Espoo (FI); Panu KOPPINEN, Espoo (FI); David GOMES MARTINS, Espoo (FI)

(21) Appl. No.: 19/120,065

(22) PCT Filed: Oct. 18, 2023
(86) PCT No.: PCT/FI2023/050590

§ 371 Date: Apr. 10, 2025

(30) Foreign Application Priority Data
Oct. 19, 2022 (FI) 20225947

(51) Int. Cl. G01F 1/667; G01F 1/66

(52) U.S. Cl. CPC G01F 1/667; G01F 1/662

(57) ABSTRACT

An ultrasound sensor arrangement comprises a plurality of ultrasound transmitting elements of an ultrasound transmitter and an ultrasound receiver with at least one ultrasound receiving element. The transmitter and the receiver are integrated together on a chip which can attached on or inserted as a part of solid material of a duct within which fluid flows for the receiving elements to receive the ultrasound signal, which is transmitted by the transmitting elements into the flow, as a reflection from the duct. The transmitting elements are between at least two receiving elements of the plurality of receiving elements, where a line of the flow and a line between said at least two receiving elements are parallel or have a predetermined angle therebetween, and/or the at least one ultrasound receiving element of the ultrasound receiver is between two groups of the ultrasound transmitter elements of the ultrasound transmitter, where a line of the flow and a line between said two groups of transmitting elements are parallel or have a predetermined angle therebetween.

### FIELD

The invention relates to an ultrasound sensor arrangement, apparatus and a method of transmitting of ultrasound.

### BACKGROUND

Ultrasound flow meters have ultrasound transmitters and receiver. Instead of different components for converting an electronic signal into ultrasound and vice versa a transducer may also both transmit and receive. A difference of a transit time of the ultrasound signal having a component in both up- and down-stream may be determined and thus a velocity of fluid can be measured. An alternative measurement is based on the Doppler-effect. Although a variety of ultrasound transmitting and receiving components, measurement configurations and measurement principles exists, the ultrasound measurement could still be improved.

### BRIEF DESCRIPTION

The present invention seeks to provide an improvement in the measurements.

The invention is defined by the independent claims. Embodiments are defined in the dependent claims.

If one or more of the embodiments is considered not to fall under the scope of the independent claims, such an embodiment is or such embodiments are still useful for understanding features of the invention.

### LIST OF DRAWINGS

Example embodiments of the present invention are described below, by way of example only, with reference to the accompanying drawings, in which

FIG. 1 illustrates an example of an ultrasound an ultrasound sensor arrangement;

FIG. 2A illustrates an example where the ultrasound transmitting elements are between two receiving elements;

FIG. 2B illustrates an example where an ultrasound receiving element is between two groups of transmitting elements;

FIG. 3 illustrates an example of a piezoelectrical micromachined ultrasound transducer (PMUT);

FIG. 4 illustrates an example of a capacitive micromachined ultrasound transducer (CMUT);

FIG. 5 illustrates an example where the ultrasound sensor comprises at least one micromachined structure which is configured to sense pressure and/or pressure changes;

FIG. 6 illustrates an example of a bloc chart of a signal processing unit;

FIG. 7 illustrates an example where ultrasound transmitters and receivers alternate in temporal cycles;

FIG. 8 illustrates an example of a comparison of flow rates measured by the ultrasound apparatus described in this document and the same flow rates determined by a standard flow meter;

FIG. 9 illustrates an example of a phase difference as a function of flow rate; and

FIG. 10 illustrates of an example of a flow chart of a measuring method.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment.

The articles “a” and “an” give a general sense of entities, structures, components, compositions, operations, functions, connections or the like in this document. Note also that singular terms may include pluralities.

Single features of different embodiments may also be combined to provide other embodiments. Furthermore, words “comprising” and “including” should be understood as not limiting the described embodiments to consist of only those features that have been mentioned and such embodiments may also contain features/structures that have not been specifically mentioned. All combinations of the embodiments are considered possible if their combination does not lead to structural or logical contradiction.

The term “about” means that quantities or any numeric values are not exact and typically need not be exact. The reason may be tolerance, resolution, measurement error, rounding off or the like, or a fact that the feature of the solution in this document only requires that the quantity or numeric value is approximately that large. A certain tolerance is always included in real life quantities and numeric values.

It should be noted that while Figures illustrate various embodiments, they are simplified diagrams that only show some structures and/or functional entities. The connections shown in the Figures may refer to logical or physical connections. It is apparent to a person skilled in the art that the described apparatus may also comprise other functions and structures than those described in Figures and text. It should be appreciated that details of some functions, structures, and the signalling used for measurement and/or controlling are irrelevant to the actual invention. Therefore, they need not be discussed in more detail here.

The term “comprise” (and grammatical variations thereof) and the term “include” should be read as “comprise without limitation” and “include without limitation”, respectively.

In this application, the term “determine” in its various grammatical forms may mean calculating, computing, data processing for deriving a result, looking up in a database or the like. As a result, “determine” may also mean select, choose or the like.

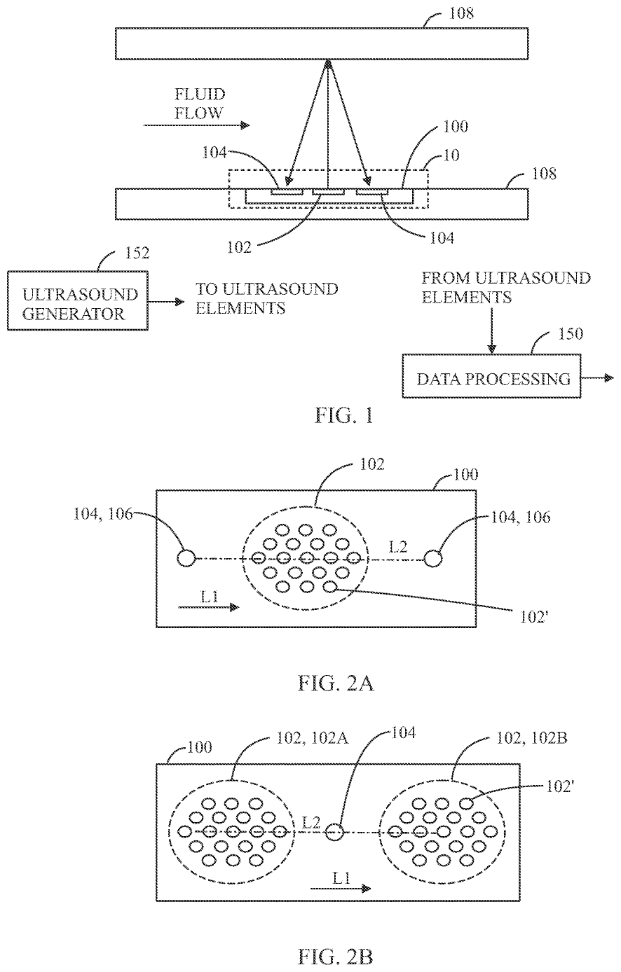

FIG. 1 illustrates an example of an ultrasound an ultrasound sensor arrangement 10, which comprises an ultrasound transmitter 102 with plurality of ultrasound transmitting elements 102′ (only one has reference number) and an ultrasound receiver 104 with a plurality of ultrasound receiving elements 106 (in FIG. 2A there are two receiving elements 106). In general, the number of the ultrasound receiving elements 106 is one or more (see FIG. 2B). Various configurations are possible, because the sensors may work as transceivers or separately transmitters and receivers. For example, it is possible to send at the same time with most edge ones and receive with the middle one(s). The ultrasound transmitter 102 and the ultrasound receiver 104 are integrated together on or within a chip 100.

The piezoelectric micromachined ultrasonic transducer body material may be silicon and the vibrating membrane may be laminate of piezo material like silicon nitrite, metals like aluminum or molybdenum, silicon or polysilicon, silicon oxide, for example. The capacitive micromachined ultrasonic transducer is made typically of similar materials without the piezo material.

The chip 100 can attached on or inserted as a part of solid material of a duct 108. The duct 108 should be understood as a general name for a flow channel. The duct 108 may be a pipe or a groove like flute, for example. In an embodiment, the chip 100 may be on an inner surface of the duct 108 in order to be in contact with the flowing fluid. However, the ultrasound transmitter 102 and the ultrasound receiver 104 may transmit and receive also through a solid material to the flowing fluid. The ultrasound transmitter 102 and the ultrasound receiver 104 are on the same side of the duct 108, i.e. this is a single side measurement geometry.

The receiving elements of the ultrasound receiver 104 receive the ultrasound signal, which is transmitted by the transmitting elements of the ultrasound transmitter 104 into the flowing fluid, as a reflection from the duct 108. The reflection may occur at the inner surface of the duct 108. The transmitting elements of the ultrasound transmitter 102 are between at least two receiving elements 106 of the receiving elements 104. As shown in example of FIG. 2A, a line L1 of the flow and a line L2 between said at least two receiving elements 106 are parallel or have a predetermined angle therebetween. As shown in example of FIG. 2B, a line L1 of the flow and a line L2 between said a center of the transmitting elements 106 are parallel or have a predetermined angle therebetween. The transceiver can be formed of multiple elements (vibrating cells) or single cell.

In this manner, the received ultrasound signal has vector component the is parallel to the direction of the flow. In one propagation direction the vector component of the ultrasound has the same direction as the flow and in another propagation direction the vector component of the ultrasound has an opposite direction to the flow. The one direction refers to a direction of a propagation of the ultrasound signal before a reflection, and another direction refers to a direction of the propagation of the ultrasound signal after the reflection. Alternatively, another direction refers to a direction of a propagation of the ultrasound signal before a reflection, and the one direction refers to a direction of the propagation of the ultrasound signal after the reflection.

FIG. 2A illustrates an example where the ultrasound transmitting elements 102′ of the transmitter 102 are between two receiving elements 106. The transmitting elements 102′ may be in a matrix form.

FIG. 2B illustrates an alternative example where the at least one ultrasound receiving element of the ultrasound receiver 104 is between two groups 102A, 102B of the ultrasound transmitter elements 102′ of the ultrasound transmitter 102. The groups of the transmitting elements 102′ may be in a matrix form. The line L1 of the flow and a line L2 between said two groups 102A, 102B of transmitting elements are parallel or have a predetermined angle therebetween. By arranging 102 in an angle it is possible to measure flow vectors. If three sensors are arranged in a triangle, x and y vectors may be measured.

By arranging the transmitter 102 and the receiver 104 in a manner illustrated in FIGS. 1, 2A and 2B, it is possible to measure a phase difference of the ultrasound signal between the receiver pair 106 which have the transmitting elements of the transmitter 102 located between them. The phase difference is directly relative to a velocity of the fluid in the duct 108. Mathematically this can be expressed as:

$$Δ Φ \approx \frac{2 k x}{c} v$$

where

$$k = \frac{2 π f}{c}$$

and ΔΦ is a phase difference, v is a velocity of the flow, f is a frequency of the ultrasound, c is the speed of the ultrasound and x is a distance between the receivers or transmitters. Finally, it can be written

$$Δ Φ ∼ v$$

which means that the phase difference is directly relative to the velocity v of the fluid in the duct 108.

Here fluid may refer to a gas and/or liquid phase of matter. The differential measurement eliminates or minimizes errors due to contamination, for example. The ultrasound sensor arrangement 10 does not disturb the flow, and it can be made smooth flat while it can be durable to wear. The ultrasound sensor arrangement can be scaled for wide variety of flow channels. In an embodiment, a length of the chip 100 may be about 10 mm, the number of the transmitting elements may be 1 to 1000, for example, and the operating ultrasound frequency may be about 400 kHz. However, the numerical values are only examples without limiting to them.

A number of transmitting elements 102′ may be larger than that of the receiving elements 106. This is useful for amplifying the transmission power, controlling or narrowing the ultrasound beam by the number of transmitting elements 102′.

FIG. 3 illustrates an example of a piezoelectrical micromachined ultrasound transducer (PMUT). At least one of the plurality of transmitting and receiving ultrasound elements 102′, 106 may comprise the piezoelectrical micromachined ultrasound transducer.

The PMUT transducer has an electric contact for a bottom electrode and a contact for a top electrode. A piezoelectrical layer is between the top and bottom electrode layer. This layered structure is on a dummy layer, which may be an isolating oxide layer. This whole layered structure may be on a silicon substrate. When pulsed voltage is applied to the electric contacts, the layered structure oscillates with the pulsed voltage causing sound waves to the surrounding fluid. On the other hand, a pressure of the surrounding fluid causes deformation of the layered structure causing an electrical potential difference to the electric contacts, which may be used for a pressure measurement. This is a mere sketch of the structure for giving an idea what kind of device the PMUT transducer is. A person skilled in the art is familiar with the PMUT transducer, per se.

The PMUT may be used as a transmitter, a receiver or a transceiver. An operating frequency may be 50 kHz to 1000 kHz, for example. In water, the operating frequency range may be 1 MHz to 10 MHz, for example. The PMUT can be driven using pulsed wave voltages. The performance may be tailored. When using a plurality of the PMUT the geometry of the arrangement may also be tailored according to the needs. A manufacturing process of the ultrasound apparatus is technically simple.

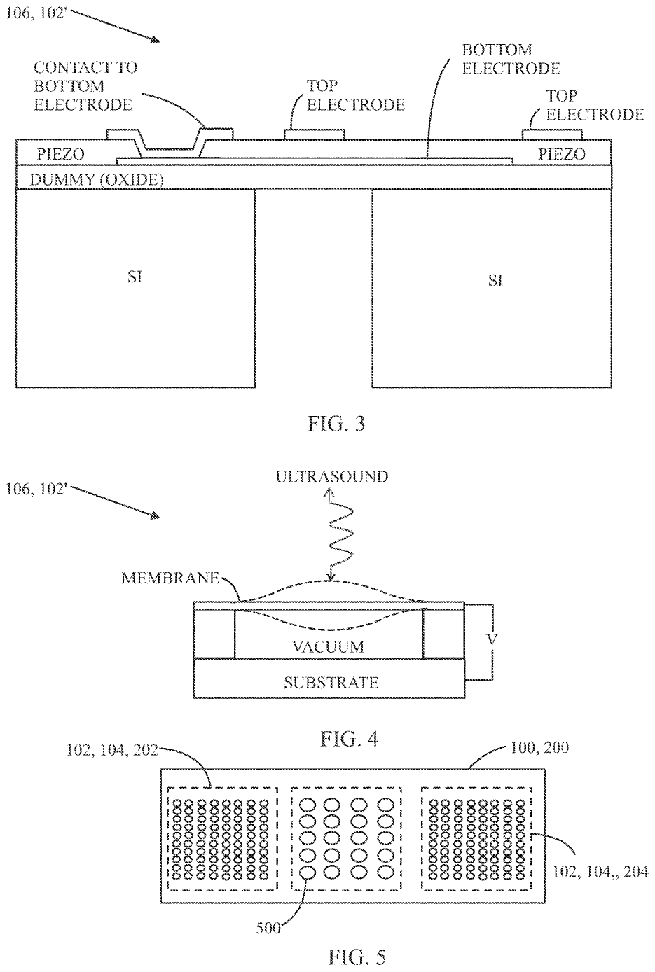

FIG. 4 illustrates an example of a capacitive micromachined ultrasound transducer (CMUT). The CMUT may be used as a transmitter, a receiver or a transceiver. At least one of the plurality of transmitting and receiving ultrasound elements 102′, 106 may comprise the capacitive micromachined ultrasound transducer.

When pulsed voltage V is applied to the electric contacts, membrane oscillates with the pulsed voltage causing sound waves to the surrounding fluid. On the other hand, a pressure of the surrounding fluid bends the membrane causing an electrical potential difference (this can also be marked with V as in FIG. 4) to the electric contacts, which may be used for a pressure measurement. This is a mere sketch of the structure for giving an idea what kind of device the CMUT transducer is. A person skilled in the art is familiar with the CMUT transducer, per se.

An operating frequency may be 1 MHz to 10 MHz, for example. The CMUT can be driven using pulsed wave voltages. The performance may be tailored. When using a plurality of the CMUT the geometry of the arrangement may also be tailored according to the needs. A manufacturing process of the ultrasound apparatus is technically simple.

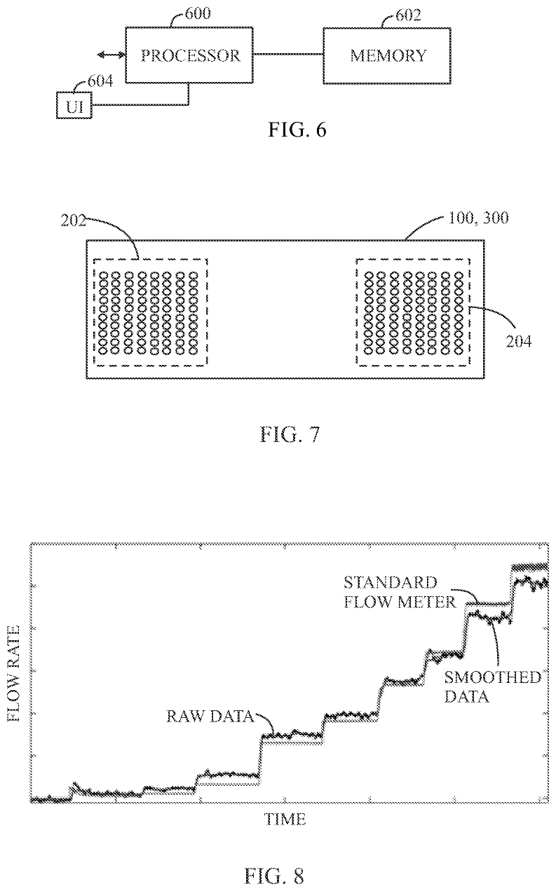

In an embodiment an example of which is illustrated in FIG. 5, the ultrasound sensor arrangement 10 may comprise and/or a separate ultrasound sensor arrangement 20 comprises at least one capacitive micromachined membrane structure 500 which is configured to sense absolute pressure or pressure changes in the duct 108. The capacitive micromachined membrane structure is similar to that of the CMUT transducer, and the capacitive micromachined membrane structure may be considered identical to the CMUT transducer. The membrane bends caused by the pressure.

The membrane structure may be optimized for different application which include a size of the duct 108, a level of the pressure and a variation range of the pressure. A smaller duct 108 may require smaller membrane structures, for example. A larger pressure or pressure range may also require smaller membrane structures, for example. The ultrasound sensos may be tailored by changing the diameter thickness and tensile strength of the membrane.

In an embodiment an example according to FIG. 5, the ultrasound sensor arrangement 10 may comprise and/or a separate ultrasound sensor arrangement comprises at least one piezoelectrical micromachined structure 500 which is configured to sense pressure changes in the duct 108. A plurality of the piezoelectrical micromachined structures 500 may be in a matrix form. The piezoelectrical micromachined membrane structure 500 is similar to that of the 20 PMUT transducer, and the piezoelectrical micromachined membrane structure may be considered identical to the PMUT transducer. The layered structure deforms caused by the pressure, the deforming depending on the pressure. As the deformation causes an electrical potential difference that is relative to the deformation at contact electrodes, the electrical potential difference can be measured, and the pressure can be determined based on the electrical potential difference.

FIG. 6 illustrates an example of a signal processing unit 150 which is also shown in FIG. 1. The ultrasound sensor apparatus comprises the signal processing unit 150. The signal processing unit 150, which may be considered a computer, comprises one or more processors 500 and one or more memories 502 including computer program code. The one or more memories 502 and the computer program code are configured to, with the one or more processors 500, cause ultrasound apparatus at least to measure a velocity of the fluid and/or a variation of the velocity of the fluid in the duct 108 based on a phase shift between the ultrasound signals received by the at least one receiving element 106. The signal processing unit 150 may also determine pressure and/or pressure changes of the fluid in the duct 108.

The term “computer” includes a computational device that performs logical and arithmetic operations. For example, a “computer” may comprise an electronic computational device, such as an integrated circuit, a microprocessor, a mobile computing device, a laptop computer, a tablet computer, a personal computer, or a mainframe computer. A “computer” may comprise a central processing unit, an ALU (arithmetic logic unit), a memory unit, and a control unit that controls actions of other components of the computer so that steps of a computer program are executed in a desired sequence. A “computer” may also include at least one peripheral unit that may include an auxiliary memory (such as a disk drive or flash memory), and/or may include data processing circuitry.

The data processing unit 150 may comprise or be connected with a user interface 604. The user interface 151 means an input/output device and/or unit. Non-limiting examples of a user interface include a touch screen, other electronic display screen, keyboard, mouse, microphone, handheld electronic controller, digital stylus, speaker, and/or projector for projecting a visual display. The user interface 604 may be used for inputting data to the ultrasound sensor apparatus and/or outputting data from the ultrasound sensor apparatus. The user interface 604 may present the measured information as a visual and/or audio output.

In an embodiment, the ultrasound sensor apparatus may comprise at least one capacitive micromachined membrane structure 500, and the signal processing unit 150 may measure pressure within the duct 108 based on signaling from the least one piezoelectrical micromachined structure 500.

In an embodiment, the ultrasound sensor apparatus may comprise at least one piezoelectrical micromachined structure 500, and the signal processing unit 150 may measure pressure changes in the duct 108 based on signaling from the least one piezoelectrical micromachined structure 500.

In an example which can be explained based on FIG. 7, the ultrasound sensor arrangement 200 comprises at least one first ultrasound element 202 and at least one second ultrasound element 204 which are integrated together on the chip 100 of FIGS. 1, 2A, 2B and/or 5, or on a separate chip 300 which is configured to be attached on or inserted as a part of solid material of a duct 108 within which fluid flows. The first and second ultrasound elements 202, 204 are configured to transmit and receive ultrasound temporally alternatively such that when the at least one first ultrasound element 202 is transmitting the at least one second ultrasound element 204 is synchronously receiving, and when the at least one second ultrasound element 204 is transmitting the at least one first ultrasound element 202 is synchronously receiving, the ultrasound being transmitted into the flow and received as a reflection from the duct 108.

FIG. 8 illustrates an example of a comparison of flow rates measured by the ultrasound apparatus described in this document and the same flow rates determined by a standard flow meter. As can be seen the measurement are very similar and differences are small.

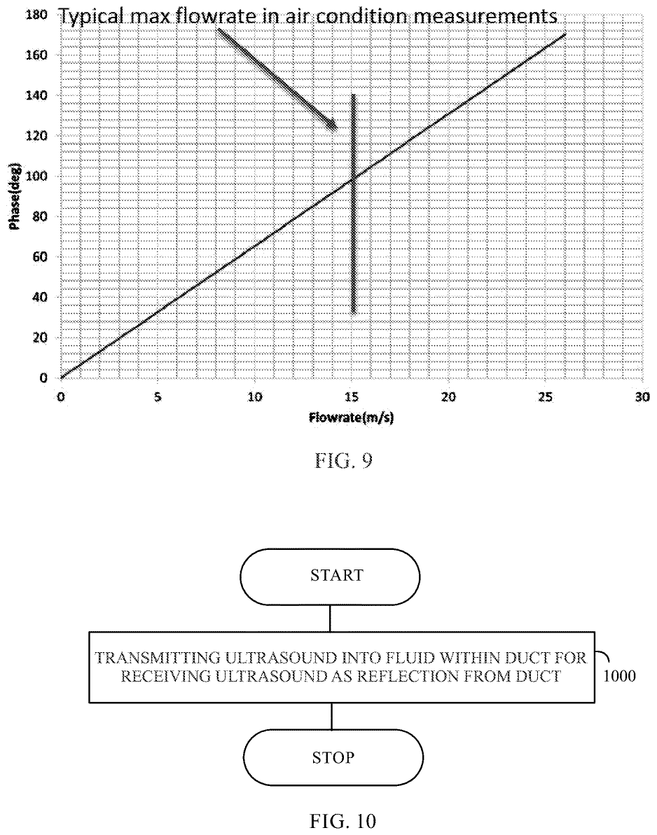

FIG. 9 illustrates an example of a phase difference (°) as a function of flow rate (m/s). In this example, the measurement frequency of the ultrasound is 300 kHz and the distance between receivers is 7 mm.

FIG. 10 is a flow chart of the measurement method. In step 1000, ultrasound is transmitted into fluid within a duct 108 by a plurality of ultrasound transmitting elements 102′ of an ultrasound transmitter 102 for the ultrasound to be reflected from the duct 108 to at least one ultrasound receiving element 106 of the ultrasound receiver 104. The operation is based on the reflection in the following structural conditions. The transmitter 102 and the receiver 104 are integrated together on a chip 100 which is configured to be attached on or inserted as a part of solid material of a duct 108 within which fluid flows. There are two possibilities for the operation. The transmitting elements 102 are between at least two receiving elements 106 of the plurality of receiving elements 104, where a line L1 of the flow and a line L2 between said at least two receiving elements 106 are parallel or have a predetermined angle therebetween. Alternatively or additionally, the at least one ultrasound receiving element of the ultrasound receiver 104 is between two groups 102A, 102B of the ultrasound transmitter elements of the ultrasound transmitter 102, where a line L1 of the flow and a line L2 between said two groups 102A, 102B of transmitting elements are parallel or have a predetermined angle therebetween.

The method shown in FIG. 10 may be implemented as a logic circuit solution or computer program. The computer program may be placed on a computer program distribution means for the distribution thereof. The computer program distribution means is readable by a data processing device, and it encodes the computer program commands, carries out the measurements and optionally controls the processes on the basis of the measurements.

The computer program may be distributed using a distribution medium which may be any medium readable by the controller. The medium may be a program storage medium, a memory, a software distribution package, or a compressed software package. In some cases, the distribution may be performed using at least one of the following: a near field communication signal, a short distance signal, and a telecommunications signal.

It will be obvious to a person skilled in the art that, as technology advances, the inventive concept can be implemented in various ways. The invention and its embodiments are not limited to the example embodiments described above but may vary within the scope of the claims.

1. An ultrasound sensor arrangement, wherein the ultrasound sensor arrangement comprises a first ultrasound element and a second ultrasound element, and they comprise a plurality of ultrasound transmitting elements of an ultrasound transmitter and an ultrasound receiver with at least two ultrasound receiving elements, the transmitter and the receiver being integrated together on a chip which is configured to be attached on or inserted as a part of solid material of a duct within which fluid flows for the receiving elements to receive the ultrasound signal, which is transmitted by the transmitting elements into the flow, as a reflection from the duct;
the first and second ultrasound elements are configured to transmit and receive ultrasound temporally alternatively such that when the ultrasound transmitting elements of the first ultrasound element are transmitting the at least two ultrasound receiving elements of the at least one second ultrasound element are synchronously receiving, and when the ultrasound transmitting elements of the second ultrasound element are transmitting the at least two ultrasound receiving elements of the first ultrasound element are synchronously receiving; and
the transmitting elements are between at least two receiving elements of the ultrasound receive, where a line of the flow and a line between said at least two receiving elements are parallel or have a predetermined angle therebetween, and/or
the at least two ultrasound receiving elements of the ultrasound receiver are between two groups of the ultrasound transmitter elements of the ultrasound transmitter, where a line of the flow and a line between said two groups of transmitting elements are parallel or have a predetermined angle therebetween.

2. The ultrasound sensor arrangement of claim 1, wherein a number of transmitting elements is larger than that of the receiving elements.

3. The ultrasound sensor arrangement of claim 1, wherein at least one of the plurality of transmitting and receiving ultrasound elements comprises a piezoelectrical micromachined ultrasound transducer.

4. The ultrasound sensor arrangement of claim 1, wherein at least one of the plurality of transmitting and receiving ultrasound elements comprises a capacitive micromachined ultrasound transducer.

5. The ultrasound sensor arrangement of claim 1, wherein the ultrasound sensor arrangement comprises at least one capacitive micromachined membrane structure which is configured to sense pressure in the duct.

6. The ultrasound sensor arrangement of claim 1, wherein the ultrasound sensor arrangement comprises at least one piezoelectrical micromachined structure which is configured to sense pressure changes in the duct.

7. An ultrasound sensor apparatus, wherein the ultrasound sensor apparatus comprises the ultrasound sensor arrangement of claim 1; and
the ultrasound sensor apparatus comprises a signal processing unit configured to determine velocity of the fluid and/or a variation of the velocity of the fluid based on a phase shift between the ultrasound signals received by the at least one receiving element.

8. The ultrasound sensor apparatus of claim 7, wherein the ultrasound sensor apparatus comprises at least one capacitive micromachined membrane structure; and the signal processing unit is configured to measure pressure in the duct based on signaling from the least one capacitive micromachined structure.

9. The ultrasound sensor apparatus of claim 7, wherein the ultrasound sensor apparatus comprises at least one piezoelectrical micromachined structure; and the signal processing unit is configured to measure pressure changes in the duct based on signaling from the least one piezoelectrical micromachined structure.

10. An ultrasound sensor method, the method comprising transmitting ultrasound, by a plurality of ultrasound transmitting elements of an ultrasound transmitter, into fluid within a duct for the ultrasound to be reflected from the duct to at least two ultrasound receiving elements of the ultrasound receiver, and
for operation based on the reflection,
the transmitter and the receiver are integrated together on a chip which is configured to be attached on or inserted as a part of solid material of a duct within which fluid flows, where
transmitting and receiving ultrasound by the first and second ultrasound elements temporally alternatively such that when the ultrasound transmitting elements of the first ultrasound element are transmitting the at least two ultrasound receiving elements of the at least one second ultrasound element are synchronously receiving, and when the ultrasound transmitting elements of the second ultrasound element are transmitting the at least two ultrasound receiving elements of the first ultrasound element are synchronously receiving; and
the transmitting elements are between at least two receiving elements of the plurality of receiving elements, where a line of the flow and a line between said at least two receiving elements are parallel or have a predetermined angle therebetween, and/or
the at least two ultrasound receiving elements of the ultrasound receiver are between two groups of the ultrasound transmitter elements of the ultrasound transmitter, where a line of the flow and a line between said two groups of transmitting elements are parallel or have a predetermined angle therebetween.
